(19) United States
(12) Patent Application Publication
(10) Pub. No.: US 2024/0126568 A1
(43) Pub. Date: Apr. 18, 2024

(54) METHOD, APPARATUS, DEVICE, COMPUTER READABLE STORAGE MEDIUM AND PRODUCT FOR PATTERN RENDERING

(71) Applicant: Beijing Zitiao Network Technology Co., Ltd., Beijing (CN)

(72) Inventors: Shiman Shi, Beijing (CN); Mingxin Wei, Beijing (CN)

(21) Appl. No.: 18/572,108

(22) PCT Filed: Aug. 2, 2022
(86) PCT No.: PCT/CN2022/109750

§ 371 Date: Dec. 19, 2023

(30) Foreign Application Priority Data
Aug. 4, 2021 (CN) 202110890943.6

(51) Int. Cl. G06F 9/448; G06F 9/38

(52) U.S. Cl. CPC G06F 9/448; G06F 9/3856

(57) ABSTRACT

Embodiments of the present disclosure provide a method, apparatus, device, computer readable storage medium, electronic device, computer product and computer program for pattern rendering. The method comprises: obtaining a pattern rendering instruction, wherein the pattern rendering instruction comprises a plurality of coordinate points to be rendered and painting attributes corresponding to the coordinate points to be rendered; performing rendering operations on respective coordinate points to be rendered in a predetermined work to be rendered according to the painting attributes corresponding to the coordinate points to be rendered in the pattern rendering instruction; if a predetermined instruction is detected, sending the rendering operation to an external display terminal in real time so that the external display terminal displays the received rendering operation in real time.

### CROSS-REFERENCE TO RELATED APPLICATIONS

The present disclosure claims the priority of the Chinese patent application entitled “method, apparatus, device, computer readable storage medium and product for pattern rendering” with the application number of 202110890943.6 and the filing date of Aug. 4, 2021, the content of which is hereby incorporated by reference in its entirety.

### FIELD

Embodiments of the present disclosure relate to the technical field of data processing and in particular, to a method, apparatus, device, computer readable storage medium, electronic device, computer product and computer program for pattern rendering.

### BACKGROUND

Shopping malls, science and technology museums, museums, industry exhibition centers, theme exhibition centers and other places with a large flow of people usually use large screens to interact with users, which may support human-computer interaction and display some user-defined content.

### SUMMARY

Embodiments of the present disclosure provide a method, apparatus, device, computer readable storage medium, electronic device, computer product and computer program for pattern rendering to solve the technical problem in that existing pattern rendering methods cannot display patterns rendered by users in real time.

In a first aspect, an embodiment of the present disclosure provides a method of pattern rendering, the method implemented at a server side and comprising:
obtaining a pattern rendering instruction comprising a plurality of coordinate points to be rendered and painting attributes corresponding to the coordinate points to be rendered;
performing a rendering operation on respective coordinate points to be rendered in a predetermined work to be rendered according to the painting attributes corresponding to the coordinate points to be rendered in the pattern rendering instruction; and
if a predetermined instruction is detected, sending the rendering operation to an external display terminal in real time so that the received rendering operation in real time is displayed at the external display terminal.

In a second aspect, an embodiment of the present disclosure provides a method of pattern rendering, the method implemented at an external display terminal and comprising:
obtaining a rendering operation, wherein the rendering operation is obtained by, after the server side obtains a pattern rendering instruction, rendering each coordinate point to be rendered in a predetermined work to be rendered according to painting attributes corresponding to the coordinate point to be rendered in the pattern rendering instruction; and
displaying the rendering operation in real time.

In a third aspect, an embodiment of the present disclosure provides an apparatus for pattern rendering, the apparatus implemented at the server side and comprising:
an obtaining module, configured to obtain a pattern rendering instruction comprising a plurality of coordinate points to be rendered and painting attributes corresponding to the coordinate points to be rendered;
a rendering module, configured to perform a rendering operation on respective coordinate points to be rendered in a predetermined work to be rendered according to the painting attributes corresponding to the coordinate points to be rendered in the pattern rendering instruction; and
a sending module, configured to, if a predetermined instruction is detected, send the rendering operation to an external display terminal in real time so that the received rendering operation in real time is displayed at the external display terminal.

In a fourth aspect, an embodiment of the present disclosure provides an apparatus for pattern rendering, the apparatus implemented at an external display terminal, and comprising:
a rendering operation obtaining module, configured to obtain a rendering operation, wherein the rendering operation is obtained by, after the server side obtains a pattern rendering instruction, rendering each coordinate point to be rendered in a predetermined work to be rendered according to painting attributes corresponding to the coordinate point to be rendered in the pattern rendering instruction; and
a display module, configured to display the rendering operation in real time.

In a fifth aspect, an embodiment of the present disclosure provides an electronic device, comprising: a processor and a memory;
the memory storing computer executable instructions;
the processor executing the computer execution instructions stored in the memory to cause the processor to perform a method of pattern rendering according to the first aspect and all possible designs of the first aspect.

In a sixth aspect, an embodiment of the present disclosure provides a computer readable storage medium storing computer executable instructions thereon that, when executed by a processor, implement a method of pattern rendering according to the first aspect and all possible designs of the first aspect.

In a seventh aspect, an embodiment of the present disclosure provides a computer program product comprising a computer program which, when executed by a processor, performs a method of pattern rendering according to the first aspect and all possible designs of the first aspect.

In an eighth aspect, an embodiment of the present disclosure provides a computer program which, when executed by a processor, performs a method of pattern rendering according to the first aspect and all possible designs of the first aspect.

### BRIEF DESCRIPTION OF THE RENDERINGS

In order to more clearly illustrate the technical solution in the embodiments of the present disclosure or the prior art, a brief introduction is presented below to the renderings required to be used in the description of the embodiments or the prior art. It is obvious that the renderings in the description below are some embodiments of the present disclosure. For those of ordinary skill in the art, they may obtain other renderings from these renderings without the exercise of any creative skill.

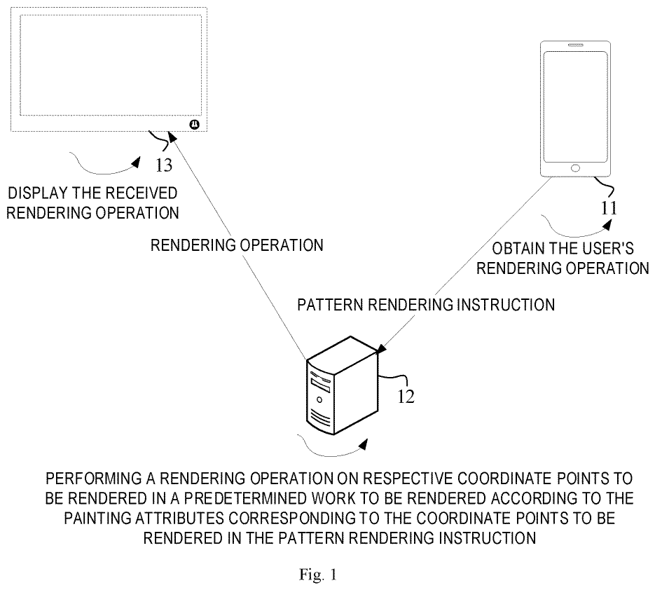

FIG. 1 is a schematic diagram of the system architecture on which the present disclosure is based;

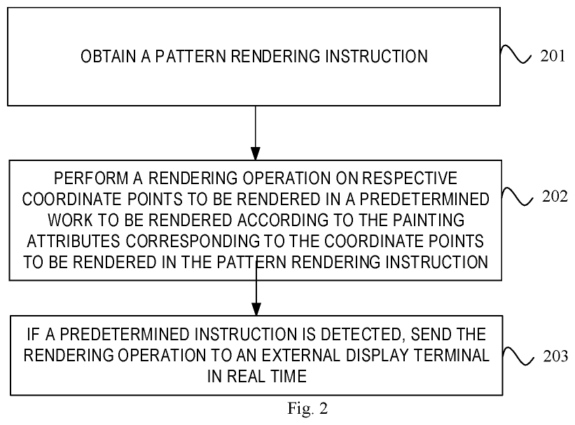

FIG. 2 is a schematic flowchart of a method of pattern rendering provided by Embodiment 1 of the present disclosure;

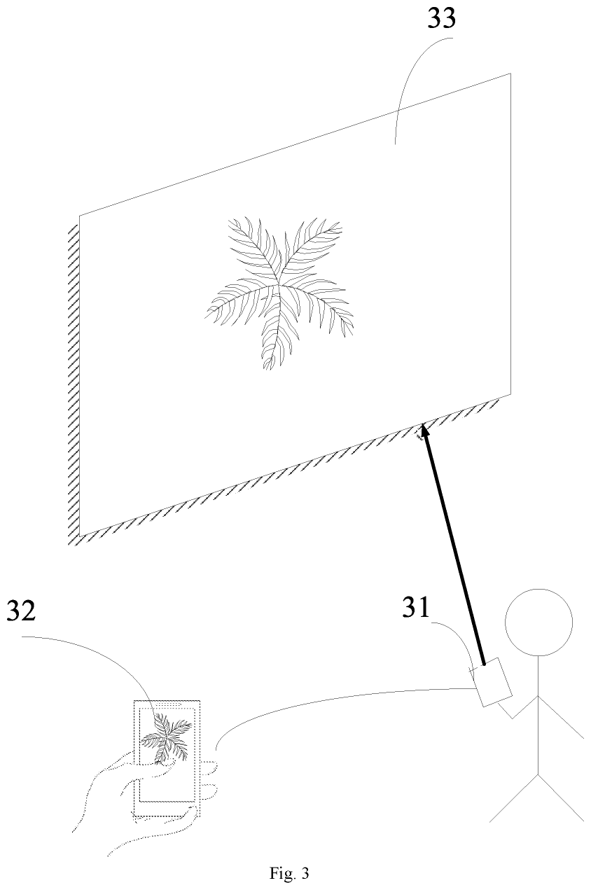

FIG. 3 is a schematic diagram of an application scenario provided by an embodiment of the present disclosure;

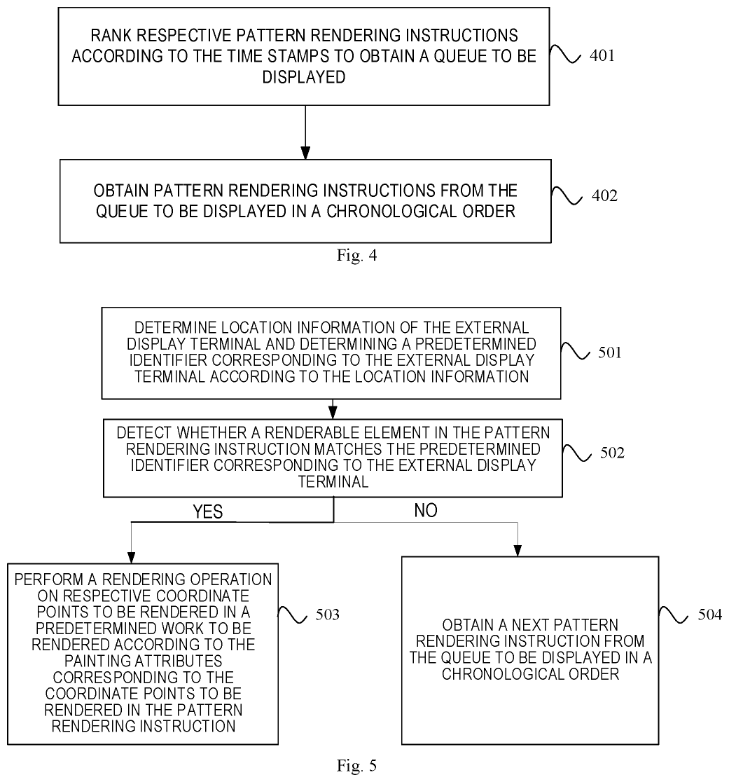

FIG. 4 is a schematic flowchart of a method of pattern rendering provided by Embodiment 2 of the present disclosure;

FIG. 5 is a schematic flowchart of a method of pattern rendering provided by Embodiment 3 of the present disclosure;

FIG. 6 is a schematic diagram of another application scenario provided by an embodiment of the present disclosure;

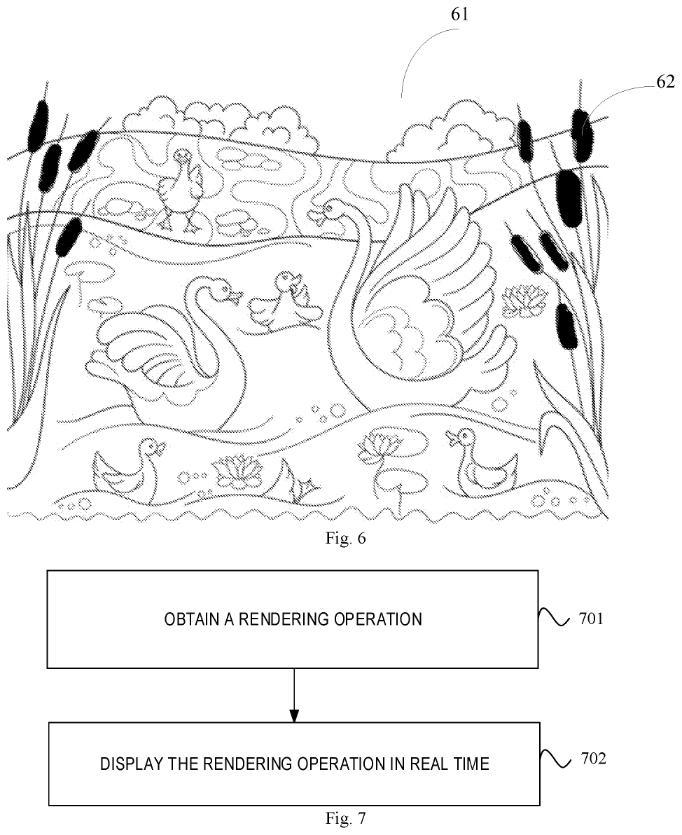

FIG. 7 is a schematic flowchart of a method of pattern rendering provided by Embodiment 4 of the present disclosure;

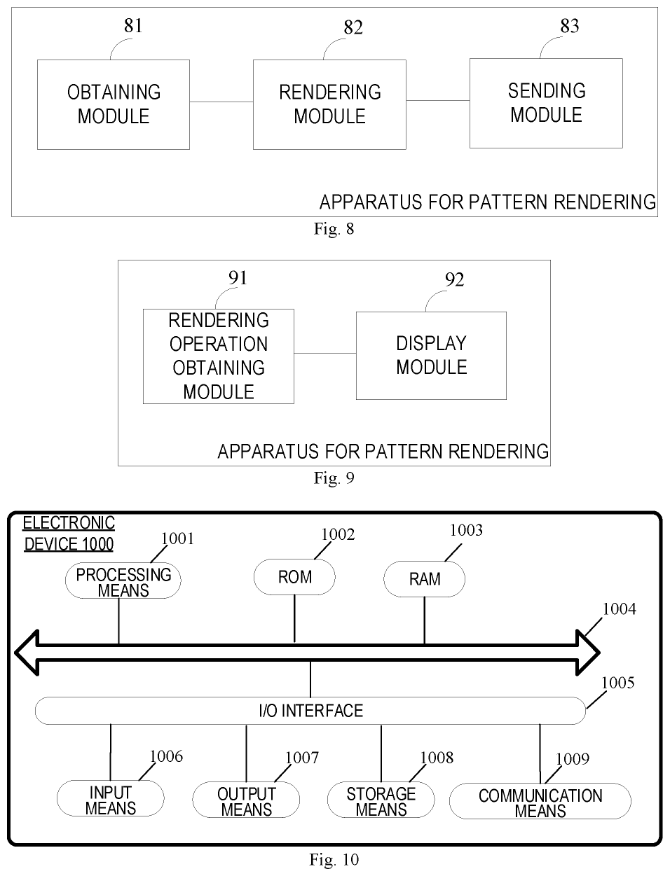

FIG. 8 is a structural schematic diagram of an apparatus for pattern rendering provided by Embodiment 5 of the present disclosure;

FIG. 9 is a structural schematic diagram of an apparatus for pattern rendering provided by Embodiment 6 of the present disclosure;

FIG. 10 is a structural schematic diagram of an electronic device provided by an embodiment of the present disclosure.

### DETAILED DESCRIPTION OF EMBODIMENTS

In order to make the objective, technical solution and advantages of the embodiments of the present disclosure clearer, the technical solution of the embodiments of the present disclosure will be clearly and completely described below in conjunction with the accompanying renderings. Obviously, the embodiments to be described are a part instead of all of the embodiments of the present disclosure. Based on the embodiments in the present disclosure, all other embodiments obtained by those of ordinary skill in the art without the exercise of any creative skill fall within the protection scope of the present disclosure.

In view of the above-mentioned technical problem that existing pattern rendering methods cannot present patterns rendered by users in real time, the present disclosure provides a method, apparatus, device, computer readable storage medium and product for pattern rendering.

It is noteworthy that the method, apparatus, device, computer readable storage medium, electronic device, computer product and computer program for pattern rendering as provided by the present disclosure may be applied to scenarios where various patterns which are rendered are displayed synchronously.

In order to present patterns rendered by users, existing methods of displaying rendered patterns need to render patterns according to the position, color and shape of the pattern rendered by the user, and present the rendered pattern. Since the pattern rendered by the user contains more content, after the user completes rendering, usually the rendered image is directly displayed. Thus, the image rendered by the user cannot be displayed in real time, so that the user cannot view the current rendering in real time and intuitively.

In the process of solving the above technical problems, the inventor has found through research that in order to display the pattern rendered by the user and the rendering process in real time, a work to be rendered may be set in advance, and the user may carry out the rendering operation according to the work to be rendered and initiate a pattern rendering instruction, wherein the pattern rendering instruction may include a plurality of coordinate points to be rendered and painting attributes of coordinate corresponding to the coordinate points to be rendered. Thus, the rendering operation may be performed on the coordinate point according to the painting attribute. Since the rendering content is refined to coordinate points, the user's rendering process may be displayed in real time.

FIG. 1 is a schematic diagram of the system architecture on which the present disclosure is based. As depicted, the system architecture on which the present disclosure is based at least comprises: a terminal device 11, a server 12 and an external display terminal 13, wherein the server 12 communicates with the terminal device 11 and the external display terminal 13 respectively. A pattern rendering apparatus may be arranged in the server 12 or the external display terminal, which may be written in C/C++, Java, Shell or Python and other languages. The terminal device 1 may be, for example, a desktop computer, a tablet computer, etc.

FIG. 2 is a schematic flowchart of a method of pattern rendering provided by Embodiment 1 of the present disclosure. As depicted, the method comprises:

Step 201: a pattern rendering instruction is obtained, wherein the pattern rendering instruction comprises a plurality of coordinate points to be rendered and painting attributes corresponding to the coordinate points to be rendered.

The actor of this embodiment is a pattern rendering apparatus, which may be coupled to the server side, and the server side can communicate with the terminal device and the external display terminal respectively.

In this implementation, the user may carry out the pattern rendering operation on the terminal device and send the pattern rendering instruction to the pattern rendering apparatus in real time. Accordingly, the pattern rendering apparatus may obtain the pattern rendering instruction sent by the terminal device, wherein the pattern rendering instruction comprises a plurality of coordinate points to be rendered and painting attributes corresponding to the coordinate points to be rendered.

Herein the terminal device may be the user's handheld terminal, or it may be any kind of terminal including a display interface and capable of human-computer interaction, such as a mobile robot or display screen arranged in shopping malls, etc.

Optionally, the user's rendering operation on the terminal device may be coloring the predetermined work to be rendered, or it may be adding rendering content to the predetermined work to be rendered. The present disclosure is not intended to limit in this regard.

Step 202: according to the painting attributes corresponding to the coordinate points to be rendered in the pattern rendering instruction, a rendering operation is performed on respective coordinate points to be rendered in the predetermined work to be rendered is rendered.

In this implementation, after obtaining the pattern rendering instruction, the pattern rendering apparatus may perform rendering operations on the coordinate points in the pre-configured work to be rendered according to the corresponding painting attributes of the coordinate points to be rendered. For example, when the rendering operation is to color the rendering work, the pattern rendering apparatus may perform the color rendering operation on the coordinate points in the rendering work according to the pattern rendering instruction. Due to the small amount of data in the rendering operation on the coordinate point, the rendering speed is faster, so that the real-time presentation of the user's rendering process can be realized.

Herein the painting attribute comprises one or more of the color attribute, brush attribute (such as pencil, crayon, brush, etc.), transparency and other attributes. For example, a coordinate point may be rendered red with a pencil based on the painting attribute.

As an implementable way, the pre-configured work to be rendered may be a painting of a retarded child or other artist.

Step 203: if a predetermined instruction is detected, the rendering operation is sent in real time to an external display terminal so that the external display terminal displays the rendering operation received in real time.

In this implementation, during the rendering operation according to the pattern rendering instruction, in order to display the rendering operation in real time, the rendering operation may be sent to an external display terminal when a predetermined instruction is detected. Thus, when obtaining the rendering operation, the external display terminal may display the rendering operation in real time, that is, present the user's rendering process in real time. Herein, the predetermined instruction may be triggered by the user, or it may be automatically triggered by the pattern rendering apparatus upon detecting the start of the rendering operation. The present disclosure is not intended to limit in this regard.

FIG. 3 is a schematic diagram of the application scenario provided by an embodiment of the disclosure. As depicted, the user may draw a pattern through a handheld terminal device 31, and the user may draw the pattern on a display interface 32 through human-computer interaction. And the rendering operation is sent to an external display terminal 33 in real time, so that the external display terminal 33 may display the rendering operation in real time.

Further, on the basis of Embodiment 1, after step 203, there is further comprised:

If a rendering operation completion instruction is detected, the rendered work is sent to the external display terminal so that the external display terminal displays the rendered work.

In this embodiment, the external display terminal may further display the rendered work, after the user has completed the rendering operation on the work to be rendered. Specifically, after detecting that the rendering has been completed according to the pattern rendering instruction, a rendering operation completion instruction may be triggered, determine the currently rendered work to be rendered according to the rendering operation completion instruction, and send the rendered work to be rendered to the external display terminal. After obtaining the rendered work, the external display terminal may display the rendered work.

The method of pattern rendering provided in this embodiment first obtains the pattern rendering instruction comprising a plurality of coordinate points to be rendered and painting attributes corresponding to the coordinate points to be rendered. According to the painting attributes corresponding to the coordinate points to be rendered in the pattern rendering instruction, each coordinate point to be rendered in the predetermined work to be rendered is rendered. By rendering each coordinate point, the rendering operation can be sent to the external display terminal in real time, and the external display terminal can display the user's current rendering operation in real time, thereby increasing the real-time performance of pattern rendering and display.

FIG. 4 is a schematic flowchart of a method of pattern rendering provided by Embodiment 2 of the present disclosure. The number of the pattern rendering instructions is at least one, and the pattern rendering instruction includes a time stamp. As depicted, step 201 specifically comprises:

Step 401: a queue to be displayed is obtained by ranking respective pattern rendering instructions according to the time stamps.

Step 402: pattern rendering instructions are obtained from the queue to be displayed in a chronological order.

In this embodiment, the external display terminal may be arranged in any kind of scenario with a large flow of people, such as a shopping mall, museum, theater, etc. Therefore, there may be multiple users at the same time to draw the work to be rendered, and the number of pattern rendering instructions is at least one. In order to display the rendering operations of all users and avoid long waiting times for users, each pattern rendering instruction includes a time stamp.

After obtaining the pattern rendering instruction, the at least one pattern rendering instruction may be ranked according to the time stamp, to obtain a queue to be displayed. Subsequently, the pattern rendering instructions may be obtained directly from the queue to be displayed in a chronological order for orderly processing.

Further, on the basis of any of the above embodiments, the work to be rendered comprises at least one renderable element consisting of the plurality of coordinate points to be rendered; the pattern rendering instruction further comprises a renderable element identifier; Step 401 specifically comprises:
grouping the pattern rendering instructions according to the renderable element identifiers.

For each renderable element, a plurality of pattern rendering instructions corresponding to the renderable element are ranked according to the time stamps, to obtain the queue to be displayed corresponding to the renderable element.

In this embodiment, the work to be rendered may comprise at least one renderable element, wherein each renderable element consists of a plurality of coordinate points to be rendered. In the rendering operation, the user may perform the rendering operation on the entire work to be rendered or a single renderable element. Therefore, for each renderable element, in order to process all the pattern rendering instructions in sequence, the pattern rendering instructions may be grouped according to the renderable element identifiers. For each renderable element, a queue to be displayed may be set corresponding to the renderable element. Specifically, a plurality of pattern rendering instructions corresponding to the renderable element may be ranked according to the time stamps to obtain the queue to be displayed corresponding to the renderable element.

As an implementable way, since there are more users performing the rendering operation, in order to enable users to locate and understand the rendering image more quickly and accurately, the pattern rendering instruction may further comprise a user identifier. Accordingly, when the external display terminal displays the rendering operation, it may further display the user identifier in the pattern rendering instruction corresponding to the rendering operation. Herein the user identifier may be, specifically, one or more of the user ID, user profile photo and user nickname.

Further, on the basis of any of the above embodiments, following step 402, there is further comprised:
Detecting whether the queue to be displayed further comprises any unprocessed pattern rendering instruction;
If not, controlling the external display terminal to display a predetermined work with rendering completed.

In this embodiment, if no user is currently performing rendering operations, or if the processing of all the current pattern rendering instructions has been completed, a completed work may be predetermined in order to enable the external display terminal to display the rendering pattern all the time.

Specifically, it may be detected whether there is any unprocessed pattern rendering instruction in the queue to be displayed. If so, pattern rendering instructions continue to be obtained for processing. Otherwise, the external display terminal may be controlled to display the predetermined completed work.

The method of pattern rendering provided in this embodiment, by ranking and processing the pattern rendering instructions in a chronological order, may sequentially display the user's rendering operations on the basis of displaying the rendering operations in real time.

FIG. 5 is a schematic flowchart of a method of pattern rendering provided by Embodiment 3 of the present disclosure. There is a correspondence between the renderable elements and predetermined identifiers; on the basis of any of the above embodiments, as shown in FIG. 5, Step 202 specifically comprises:

Step 501: determining location information of the external display terminal, and determining a predetermined identifier corresponding to the external display terminal according to the location information.

Step 502: detecting whether a renderable element in the pattern rendering instruction matches the predetermined identifier corresponding to the external display terminal.

Step 503: if the renderable element in the pattern rendering instruction matches the predetermined identifier corresponding to the external display terminal, performing a rendering operation on respective coordinate points to be rendered in a predetermined work to be rendered according to the painting attributes corresponding to the coordinate points to be rendered in the pattern rendering instruction.

Step 504: if the renderable element in the pattern rendering instruction does not match the predetermined identifier corresponding to the external display terminal, obtaining a next pattern rendering instruction from the queue to be displayed in a chronological order.

In this embodiment, the pre-configured work to be rendered may comprise multiple different renderable elements. In order to improve the interest and applicability of pattern rendering, for each renderable element, a predetermined identifier corresponding to the renderable element may be pre-configured. The predetermined identifier may be specifically city identifiers, thus controlling different renderable elements to be displayed in different cities. Herein, the predetermined identifiers may correspond to the renderable elements one by one, or a predetermined identifier may correspond to multiple renderable elements.

Specifically, after obtaining the pattern rendering instruction, the location information of the external display terminal for displaying the rendering process may be determined first, and then the predetermined identifier corresponding to the location information may be determined. The pattern rendering instruction is detected according to the predetermined identifier to determine whether the renderable elements in the pattern rendering instruction match the predetermined identifier corresponding to the external display terminal. If yes, a rendering operation may be performed on each coordinate point to be rendered in the predetermined work to be rendered according to the painting attributes corresponding to the coordinate points to be rendered in the pattern rendering instruction.

On the contrary, if not, the next pattern rendering instruction may be obtained from the queue to be displayed for processing. Specifically, the next pattern rendering instruction may be obtained in a chronological order.

For example, if the work to be rendered includes flowers, trees, buildings, clouds and other elements, it may be set in advance that the predetermined identifier corresponding to flowers and plants is city A, the predetermined identifier corresponding to trees is city B, the predetermined identifier corresponding to buildings is city C, and the predetermined identifier corresponding to clouds is city D. In this way, it may be controlled subsequently that the external display terminal arranged in city A only displays the painting operation of flowers and plants, the external display terminal corresponding to city B only displays the rendering operation corresponding to trees, the external display terminal corresponding to city C only displays the rendering operation corresponding to buildings, and the external display terminal corresponding to city D only displays the rendering operation corresponding to clouds.

Further, on the basis of Embodiment 1, before step 201, there is further comprised:
obtaining an identification pattern associated with the predetermined identifier;
obtaining a renderable element comprising the predetermined identifier;
entering a rendering interface.

In this embodiment, the identification pattern associated with the predetermined identifier may first be obtained before the rendering operation is performed. In particular, the trigger operation of the identification pattern associated with the predetermined identifier may be realized by scanning a two-dimensional code, etc. For example, the predetermined identifier may be a city identifier, and the two-dimensional code pattern may be arranged in shopping malls, museums and other places with a large flow of people and external display terminals. Users may scan the two-dimensional code pattern through the terminal device to enter the city's activity interface and obtain the renderable elements on the activity interface.

Since the renderable element corresponds to the predetermined identifier one by one, the renderable element corresponding to the current location information may be directly displayed to the user before the user draws. Specifically, it is possible to obtain the renderable element, wherein the renderable element comprises a predetermined identifier. Then, the rendering interface corresponding to the renderable element is entered. The user can complete the rendering operation of the renderable element within the rendering interface.

As an implementable way, since the predetermined work to be rendered comprises multiple renderable elements, the user may select the corresponding renderable elements according to the actual needs for rendering operations. Specifically, the user may be provided with an interface for the selection of renderable elements. After determining the renderable elements selected by the user, the user may enter the corresponding rendering interface of the renderable elements.

FIG. 6 is a schematic view of another application scenario provided by an embodiment of the present embodiment. As shown in FIG. 6, the renderable element corresponding to the predetermined identifier in the work to be rendered 61 may be reeds 62. Therefore, only reeds 62 may be displayed without displaying the colors of other renderable elements in the work to be rendered 61.

Optionally, on the basis of any of the above embodiments, Step 202 specifically comprises:

If the external display terminal is a predetermined target external display terminal, the pattern rendering instruction corresponding to each renderable element is obtained in a chronological order from the queue to be displayed corresponding to each renderable element.

According to the painting attributes corresponding to the coordinate points to be rendered in the pattern rendering instruction corresponding to each renderable element, the rendering operation is performed on all the coordinate points to be rendered in the predetermined work to be rendered.

In this embodiment, after controlling each external display terminal to display the renderable elements corresponding to its predetermined identifier, a target external display terminal may be configured to display the rendering operation of all the renderable elements.

Specifically, if it is detected that the current external display terminal is the predetermined target external display terminal, the pattern rendering instructions corresponding to each renderable element may be obtained from the queue to be displayed corresponding to each renderable element in a chronological order. According to the painting attributes corresponding to the coordinate points to be rendered in each pattern rendering instruction, the rendering operation is performed on all the coordinate points to be rendered in the predetermined works to be rendered.

By controlling different renderable elements to be displayed in different cities and controlling the predetermined target external display terminal to display the rendering operation of all renderable elements, the method of pattern rendering provided in this embodiment may increase the gameplay of pattern rendering.

FIG. 7 is a schematic flowchart of a method of pattern rendering provided in Embodiment 4 of the present disclosure. As depicted, the method comprises:

Step 701: obtaining a rendering operation, wherein the rendering operation is obtained by, after the server side obtaining a pattern rendering instruction, rendering each coordinate point to be rendered in a predetermined work to be rendered according to painting attributes corresponding to the coordinate point to be rendered in the pattern rendering instruction.

Step 702: displaying the rendering operation in real time.

The actor of this embodiment is a pattern rendering apparatus, coupled to an external display terminal which may communicate with a server respectively.

In this embodiment, the external display terminal may obtain a rendering operation sent by the server, wherein the rendering operation is obtained by the server, after obtaining the pattern rendering instruction sent by the terminal device, rendering the coordinate point in the pre-configured work to be rendered according to the painting attributes corresponding to the coordinate point to be rendered. Due to the small amount of data in the rendering operation of the coordinate point, the rendering speed is quite fast, so that the rendering operation may be transmitted and presented in real time. Herein the painting attribute comprises one or more of the color attribute, brush attribute (such as pencil, crayon, brush, etc.), transparency and other attributes.

Further, on the basis of Embodiment 4, the number of the pattern rendering instructions is at least one, and Step 702 specifically comprises:
displaying the rendering operation corresponding to at least one pattern rendering instruction in real time.

In this embodiment, there may be multiple users performing rendering operations on the work to be rendered at the same time, and the number of pattern rendering instructions is at least one. Therefore, the rendering operation corresponding to the at least one pattern rendering instruction may be displayed in real time.

Optionally, in order to increase the user's understanding of the current display and the location of the rendering operation, the identifier of the user who has initiated the rendering operation corresponding to the renderable element may further be displayed in a predetermined area around each renderable element. Herein the user identifier may be one or more of the user ID, user avatar, and user nickname.

For example, the external display terminal currently displays the rendering operation of a renderable element, i.e., trees. Then, the identifier of user A who has initiated the rendering operation may be displayed in a predetermined area around the renderable element. Thus, user A may quickly locate the renderable element he/she is currently rendering on the external display terminal.

By rendering each coordinate point, the method of pattern rendering provided in this embodiment can send the rendering operation to the external display terminal in real time, and the external display terminal can display the user's current rendering operation in real time, thus increasing the real-time performance of pattern rendering and display.

Further, on the basis of Embodiment 4, the work to be rendered comprises renderable elements, and there is a correspondence between the renderable element and a predetermined identifier; Step 702 specifically comprises:
determining the predetermined identifier.
displaying in real time the rendering operation of a renderable element corresponding to the predetermined identifier.

In this embodiment, in order to improve the interest and applicability of pattern rendering, with respect to each renderable element, a predetermined identifier corresponding to the renderable element may be pre-configured. The predetermined identifier may be specifically a city identifier, thereby controlling different renderable elements to be displayed in different cities. Specifically, the predetermined identifier may correspond to a renderable element one by one, or a single predetermined identifier may correspond to multiple renderable elements.

In practical use, the predetermined identifiers may correspond to renderable elements one by one. For city A, the renderable element may be the sky, and for city B, the renderable element may be the sea.

Still take practical use as an example. One predetermined identifiers may correspond to multiple renderable elements. The renderable elements for city A may comprise the sky and forest, and the renderable elements for city B may be animals, clouds, rivers, etc.

Therefore, during displaying the rendering operation in real time, first the predetermined identifier corresponding to the external display terminal may be determined, and the rendering operation of the renderable element corresponding to the predetermined identifier may be displayed in real time. If the renderable element corresponding to the currently received rendering operation does not match the predetermined identifier, the rendering operation may not be displayed. Specifically, the predetermined identifier can be a city identifier. Therefore, the current location of the external display terminal may be determined first, and the corresponding predetermined identifier may be determined according to the current location.

Further, on the basis of Embodiment 4, there is further comprised: displaying an identification pattern associated with the predetermined identifier.

In this embodiment, the identification pattern associated with the predetermined identifier may further be displayed on the external display terminal in order to enable the user to obtain the renderable element and carry out the rendering operation. Herein, the identification pattern associated with the predetermined identifier may be a two-dimensional code. The user may enter the activity entrance by scanning the QR code, select a renderable element and perform the rendering operation.

Further, on the basis of Embodiment 4, the displaying the rendering operation of the renderable elements corresponding to the predetermined identifier in real time comprises:
obtaining an interactive predetermined identifier, which corresponds to an interactive rendering element of a second external display terminal;
detecting whether a rendered pattern corresponding to the interactive predetermined identifier is obtained;
if the rendered pattern corresponding to the interactive predetermined identifier is obtained, displaying the rendering operation of the renderable element corresponding to the predetermined identifier in real time, and displaying the rendered pattern corresponding to the interactive rendering element.

In this embodiment, in order to improve the display effect of the work to be rendered during the rendering operation, the rendered pattern of other renderable elements may be displayed interactively during the rendering operation on the renderable element corresponding to the predetermined identifier.

In particular, an interactive predetermined identifier may be obtained, wherein the interactive predetermined identifier corresponds to an interactive rendering element that may be displayed in association with the renderable element.

For example, the rendered pattern corresponding to the interactive predetermined identifier may be a pattern upon completion of the rendering corresponding to other draftable elements corresponding to the current city, or the rendered pattern corresponding to the interactive predetermined identifier may be a pattern upon completion of the rendering of renderable elements corresponding to other cities.

It is detected whether the rendered pattern corresponding to the interactive identifier is obtained. If yes, the rendered pattern corresponding to other renderable elements may be displayed while the rendering operation of renderable elements corresponding to the predetermined identifier is being displayed in real time.

In practical application, for example, the renderable element corresponding to city A may be the sky, and the renderable element corresponding to city B may be the sea. When the external display terminal corresponding to city A displays the rendering operation of the sky pattern, the rendered pattern of sea corresponding to city B may be displayed.

Further, on the basis of Embodiment 4, Step 702 specifically comprises:

If the external display terminal is determined to be the predetermined target external display terminal according to the predetermined identifier, the rendering operations corresponding to all the renderable elements are displayed in real time.

In this embodiment, after controlling each external display terminal to display the renderable elements corresponding to its predetermined identifier, a target external display terminal may be configured, using which the rendering operations of all the renderable elements are displayed.

Specifically, if the current external display terminal is detected as the predetermined target external display terminal, the pattern rendering instructions corresponding to each renderable element may be obtained from the queue corresponding to each renderable element to be displayed in a chronological order. The rendering operations corresponding to all the renderable elements may be displayed in real time.

The method of pattern rendering provided in this embodiment may increase the play of pattern rendering by controlling different cities to display different renderable elements and controlling the predetermined target external display terminal to display the rendering operations of all renderable elements.

FIG. 8 is a structural schematic diagram of an apparatus for pattern rendering provided in Embodiment 5 of the present disclosure. The apparatus for pattern rendering is applied to the server side, and as depicted, comprises: an obtaining module 81, a rendering module 82, and a sending module 83. Herein, the obtaining module 81 is configured to obtain a pattern rendering instruction comprising a plurality of coordinate points to be rendered and painting attributes corresponding to the coordinate points to be rendered. The rendering module 82 is configured to perform a rendering operation on respective coordinate points to be rendered in a predetermined work to be rendered according to the painting attributes corresponding to the coordinate points to be rendered in the pattern rendering instruction. The sending module 83 is configured to, if a predetermined instruction is detected, send the rendering operation to an external display terminal in real time so that the received rendering operation in real time is displayed at the external display terminal.

Further, on the basis of Embodiment five, the apparatus further comprises: the sending module, further configured to, if a rendering operation completion instruction is detected, send the rendered work to the external display terminal so that the rendered work is displayed at the external display terminal.

Further, on the basis of Embodiment five, the number of the pattern rendering instructions is at least one, and the pattern rendering instruction comprises a time stamp; the obtaining module is configured to: rank respective pattern rendering instructions according to the time stamps to obtain a queue to be displayed; obtain pattern rendering instructions from the queue to be displayed in a chronological order.

Further, on the basis of Embodiment five, the work to be rendered comprises at least one renderable element formed by the plurality of coordinate points to be rendered; the pattern rendering instruction further comprises a renderable element identifier; the rendering module is configured to: group t the pattern rendering instructions according to the renderable element identifiers; for each renderable element, rank a plurality of pattern rendering instructions corresponding to the renderable element according to the time stamps to obtain a queue to be displayed corresponding to the renderable element.

Further, on the basis of Embodiment five, the apparatus further comprises: a detecting module, configured to detect whether the queue to be displayed comprises an unprocessed pattern rendering instruction; a processing module, configured to if the queue to be displayed does not comprise an unprocessed pattern rendering instruction, control the external display terminal to display a predetermined work with rendering completed.

Further, on the basis of Embodiment five, there is a correspondence between the renderable element and a predetermined identifier; the rendering module is configured to: determine location information of the external display terminal and determine a predetermined identifier corresponding to the location information; detect whether a renderable element in the pattern rendering instruction matches the predetermined identifier corresponding to the external display terminal; if the renderable element in the pattern rendering instruction matches the predetermined identifier corresponding to the external display terminal, perform a rendering operation on respective coordinate points to be rendered in a predetermined work to be rendered according to the painting attributes corresponding to the coordinate points to be rendered in the pattern rendering instruction.

Further, on the basis of Embodiment five, the rendering module is further configured to: if a next pattern rendering instruction from the queue to be displayed in a chronological order, obtain a next pattern rendering instruction from the queue to be displayed in a chronological order.

Further, on the basis of Embodiment 5, the rendering module is configured to: the external display terminal is a predetermined target external display terminal, obtain a pattern rendering instruction corresponding to each renderable element from the queue corresponding to each renderable element in a chronological order; perform the rendering operation on all coordinate points to be rendered in the predetermined work to be rendered according to painting attributes corresponding to the coordinate points to be rendered in the pattern rendering instruction corresponding to each renderable element.

Further, on the basis of Embodiment five, the apparatus further comprises: the obtaining module, further configured to obtain an identification pattern associated with the predetermined identifier; and obtain a renderable element comprising the predetermined identifier; a preprocessing module, configured to enter a rendering interface.

FIG. 9 is a structural schematic diagram of an apparatus for pattern rendering provided in Embodiment 6 of the present disclosure, which is applied to an external display terminal. The apparatus for pattern rendering comprises: a rendering operation obtaining module 91 and a display module 92. Herein, the rendering operation obtaining module 91 is configured to obtain a rendering operation, wherein the rendering operation is obtained by, after the server side obtains a pattern rendering instruction, rendering each coordinate point to be rendered in a predetermined work to be rendered according to painting attributes corresponding to the coordinate point to be rendered in the pattern rendering instruction; the display module 92 is configured to display the rendering operation in real time.

Further, on the basis of Embodiment 6, the work to be rendered comprises a plurality of renderable elements, and there is a correspondence between the renderable element and a predetermined identifier; the display module is configured to: determine the predetermined identifier; display a rendering operation of a renderable element corresponding to the predetermined identifier in real time.

Further, on the basis of Embodiment six, the display module is configured to: obtain an interactive predetermined identifier corresponding to an interactive rendering element capable of being displayed in association with the renderable element; detect whether a rendered pattern corresponding to the interactive predetermined identifier is obtained; if the rendered pattern corresponding to the interactive predetermined identifier is obtained, display a rendering operation of a renderable element corresponding to the predetermined identifier in real time, and displaying the rendered pattern corresponding to the interactive rendered element.

Further, on the basis of Embodiment six, there is further comprised: displaying an identification pattern associated with the predetermined identifier.

Further, on the basis of Embodiment 6, the number of the pattern rendering instructions is at least one, and the display module is used to: display a rendering operation corresponding to the at least one pattern rendering instruction in real time.

The apparatus provided by this embodiment can be used to implement the technical solution of the above method embodiments, with similar implementation principles and technical effects, which is not detailed in this embodiment.

A further embodiment of the present disclosure also provides a computer readable storage medium in which computer execution instructions are stored which, when executed by a processor, implement a method of pattern rendering as described in any of the above embodiments.

A further embodiment of the present disclosure also provides a computer program product, including a computer program which, when executed by a processor, implements a method of pattern rendering as described in any of the above embodiments.

A further embodiment of the present disclosure also provides an electronic device, which comprises: a processor and a memory;
the memory storing computer executable instructions;
the processor executing the computer execution instructions stored in the memory such that the processor executes a method of pattern rendering as described in any of the above embodiments.

A further embodiment of the present disclosure also provides a computer program which, when executed by a processor, implements a method of pattern rendering as described in any of the above embodiments.

FIG. 10 shows a structural schematic diagram of an electronic device 900 suitable for implementing the embodiments of the present disclosure. The electronic device 1000 may be a terminal device or server. The terminal device may include, without limitation to, a mobile terminal such as a mobile phone, a laptop computer, a digital broadcast receiver, a PDA (personal digital assistant), a PAD (tablet computer), a PMP (portable multimedia player), an on-board terminal (e.g., on-board navigation terminal) and the like, as well as a fixed terminal such as a digital TV, a desktop computer and the like. The electronic device shown in FIG. 10 is merely an example and should not be construed to impose any limitations on the functionality and use scope of the embodiments of the present disclosure.

As shown in FIG. 10, the electronic device 1000 may comprises processing means (e.g., a central processor, a graphics processor) 1001 which is capable of performing various appropriate actions and processes in accordance with programs stored in a read only memory (ROM) 1002 or programs loaded from storage means 908 to a random access memory (RAM) 1003. In the RAM 1003, there are also stored various programs and data required by the electronic device 1000 when operating. The processing means 1001, the ROM 1002 and the RAM 1003 are connected to one another via a bus 1004. An input/output (I/O) interface 1005 is also connected to the bus 1004.

Usually, the following means may be connected to the I/O interface 1005: input means 1006 including a touch screen, a touch pad, a keyboard, a mouse, a camera, a microphone, an accelerometers, a gyroscope, or the like; output means 1007, such as a liquid-crystal display (LCD), a loudspeaker, a vibrator, or the like; storage means 1008, such as a magnetic tape, a hard disk or the like; and communication means 1009. The communication means 1009 allows the electronic device 1000 to perform wireless or wired communication with other device so as to exchange data with other device. While FIG. 10 shows the electronic device 1000 with various means, it should be understood that it is not required to implement or have all of the illustrated means. Alternatively, more or less means may be implemented or exist.

Specifically, according to the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program including program codes for executing the method shown in the flowchart. In such an embodiment, the computer program may be loaded and installed from a network via the communication means 1009, or installed from the storage means 1008, or installed from the ROM 1002. The computer program, when executed by the processing means 1001, perform the above functions defined in the method of the embodiments of the present disclosure.

It is noteworthy that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium including or storing a program that may be used by or in conjunction with an instruction executing system, apparatus or device. In the present disclosure, the computer readable signal medium may include data signals propagated in the baseband or as part of the carrier waveform, in which computer readable program code is carried. Such propagated data signals may take a variety of forms, including without limitation to electromagnetic signals, optical signals, or any suitable combination of the foregoing. The computer readable signal medium may also be any computer readable medium other than a computer readable storage medium that may send, propagate, or transmit a program for use by, or in conjunction with, an instruction executing system, apparatus, or device. The program code contained on the computer readable medium may be transmitted by any suitable medium, including, but not limited to, a wire, a fiber optic cable, RF (radio frequency), etc., or any suitable combination thereof.

The above computer readable medium may be contained in the above electronic device; or it may exist separately and not be assembled into the electronic device.

The above computer readable medium carries one or more programs which, when executed by the electronic device, cause the electronic device to perform the method described in the above embodiments.

Computer program code for carrying out operations of the present disclosure may be written in one or more program designing languages or a combination thereof, which include without limitation to an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Units involved in the embodiments of the present disclosure as described may be implemented in software or hardware. The name of a unit does not form any limitation on the module itself. For example, the first obtaining unit may further be described as a “unit used to obtain at least two Internet protocol addresses.”

The functionality described above may at least partly be performed, at least in part, by one or more hardware logic components. For example and in a non-limiting sense, exemplary types of hardware logic components that can be used include: field-programmable gate arrays (FPGA), application specific integrated circuits (ASICs), application specific standard products (ASSPs), systems on chips (SOCs), complex programmable logic devices (CPLDs), etc.

In the context of the present disclosure, the machine readable medium may be a tangible medium that can retain and store programs for use by or in conjunction with an instruction execution system, apparatus or device. The machine readable medium of the present disclosure can be a machine readable signal medium or a machine readable storage medium. The machine readable medium may include, but is not limited to, an electronic, magnetic, optical, electromagnetic, infrared or semiconductor system, apparatus or device, or any combination of the foregoing. More specific examples of the machine readable storage medium may include, without limitation to, the following: an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

In a first aspect, according to one or more embodiments of the present disclosure, provided is a method of pattern rendering, the method implemented at a server side and comprising:
obtaining a pattern rendering instruction comprising a plurality of coordinate points to be rendered and painting attributes corresponding to the coordinate points to be rendered;
performing a rendering operation on respective coordinate points to be rendered in a predetermined work to be rendered according to the painting attributes corresponding to the coordinate points to be rendered in the pattern rendering instruction; and
if a predetermined instruction is detected, sending the rendering operation to an external display terminal in real time so that the received rendering operation in real time is displayed at the external display terminal.

According to one or more embodiments of the present disclosure, if a predetermined instruction is detected, sending the rendering operation to an external display terminal in real time so that the received rendering operation in real time is displayed at the external display terminal comprises:
if a rendering operation completion instruction is detected, sending the rendered work to the external display terminal so that the rendered work is displayed at the external display terminal.

According to one or more embodiments of the present disclosure, the pattern rendering instruction of at least one pattern rendering instruction comprises a time stamp; and obtaining a pattern rendering instruction sent by a terminal device comprises:
ranking respective pattern rendering instructions according to the time stamps to obtain a queue to be displayed; and
obtaining pattern rendering instructions from the queue to be displayed in a chronological order.

According to one or more embodiments of the present disclosure, the work to be rendered comprises at least one renderable element formed by the plurality of coordinate points to be rendered; and the pattern rendering instruction further comprises a renderable element identifier; and
ranking respective pattern rendering instructions according to the time stamps to obtain a queue to be displayed comprises:
grouping the pattern rendering instructions according to the renderable element identifiers;
for each renderable element, ranking a plurality of pattern rendering instructions corresponding to the renderable element according to the time stamps to obtain a queue to be displayed corresponding to the renderable element.

According to one or more embodiments of the present disclosure, after obtaining pattern rendering instructions from the queue to be displayed in the chronological order, the method further comprises:
detecting whether the queue to be displayed comprises an unprocessed pattern rendering instruction; and
if the queue to be displayed does not comprise an unprocessed pattern rendering instruction, controlling the external display terminal to display a predetermined work with rendering completed.

According to one or more embodiments of the present disclosure, a correspondence between the renderable element and a predetermined identifier is present;
performing a rendering operation on respective coordinate points to be rendered in a predetermined work to be rendered according to the painting attributes corresponding to the coordinate points to be rendered in the pattern rendering instruction comprises:
determining location information of the external display terminal and determining a predetermined identifier corresponding to the external display terminal according to the location information;
detecting whether a renderable element in the pattern rendering instruction matches the predetermined identifier corresponding to the external display terminal; and
if the renderable element in the pattern rendering instruction matches the predetermined identifier corresponding to the external display terminal, performing a rendering operation on respective coordinate points to be rendered in a predetermined work to be rendered according to the painting attributes corresponding to the coordinate points to be rendered in the pattern rendering instruction.

According to one or more embodiments of the present disclosure, after detecting whether a renderable element in the pattern rendering instruction matches the predetermined identifier corresponding to the external display terminal, the method further comprises:
if the renderable element in the pattern rendering instruction does not match the predetermined identifier corresponding to the external display terminal, obtaining a next pattern rendering instruction from the queue to be displayed in a chronological order.

According to one or more embodiments of the present disclosure, performing a rendering operation on respective coordinate points to be rendered in a predetermined work to be rendered according to the painting attributes corresponding to the coordinate points to be rendered in the pattern rendering instruction comprises:
if the external display terminal is a predetermined target external display terminal, obtaining a pattern rendering instruction corresponding to each renderable element from the queue corresponding to the renderable element in a chronological order; and
performing the rendering operation on all coordinate points to be rendered in the predetermined work to be rendered according to painting attributes corresponding to the coordinate points to be rendered in the pattern rendering instruction corresponding to each renderable element.

According to one or more embodiments of the present disclosure, before obtaining a pattern rendering instruction, the method further comprises:
obtaining an identification pattern associated with the predetermined identifier;
obtaining a renderable element comprising the predetermined identifier; and
entering a rendering interface.

In a second aspect, according to one or more embodiments of the present disclosure, a method of pattern rendering, the method implemented at an external display terminal and comprising:
obtaining a rendering operation, wherein the rendering operation is obtained by, after the server side obtains a pattern rendering instruction, rendering each coordinate point to be rendered in a predetermined work to be rendered according to painting attributes corresponding to the coordinate point to be rendered in the pattern rendering instruction; and
displaying the rendering operation in real time.

According to one or more embodiments of the present disclosure, the work to be rendered comprises a plurality of renderable elements, and a correspondence between the renderable elements and a predetermined identifier is present; and displaying the rendering operation in real time comprises:
determining the predetermined identifier; and
displaying a rendering operation of a renderable element corresponding to the predetermined identifier in real time.

According to one or more embodiments of the present disclosure, displaying a rendering operation of a renderable element corresponding to the predetermined identifier in real time comprises:
obtaining an interactive predetermined identifier corresponding to an interactive rendering element capable of being displayed in association with the renderable element;
detecting whether a rendered pattern corresponding to the interactive predetermined identifier is obtained; and
if the rendered pattern corresponding to the interactive predetermined identifier is obtained, displaying a rendering operation of a renderable element corresponding to the predetermined identifier in real time, and displaying the rendered pattern corresponding to the interactive rendered element.

According to one or more embodiments of the present disclosure, the method further comprises: displaying an identification pattern associated with the predetermined identifier.

According to one or more embodiments of the present disclosure, the number of the pattern rendering instructions is at least one, and displaying the rendering operation in real time comprises: displaying a rendering operation corresponding to the at least one pattern rendering instruction in real time.

In a third aspect, according to one or more embodiments of the present disclosure, an apparatus for pattern rendering is provided, the apparatus implemented at the server side and comprising:
an obtaining module, configured to obtain a pattern rendering instruction comprising a plurality of coordinate points to be rendered and painting attributes corresponding to the coordinate points to be rendered;
a rendering module, configured to perform a rendering operation on respective coordinate points to be rendered in a predetermined work to be rendered according to the painting attributes corresponding to the coordinate points to be rendered in the pattern rendering instruction; and
a sending module, configured to, if a predetermined instruction is detected, send the rendering operation to an external display terminal in real time so that the received rendering operation in real time is displayed at the external display terminal.

According to one or more embodiments of the present disclosure, the apparatus further comprises: the sending module, further configured to, if a rendering operation completion instruction is detected, send the rendered work to the external display terminal so that the rendered work is displayed at the external display terminal.

According to one or more embodiments of the present disclosure, the pattern rendering instruction of at least one pattern rendering instruction comprises a time stamp; the obtaining module is configured to: rank respective pattern rendering instructions according to the time stamps to obtain a queue to be displayed; and obtain pattern rendering instructions from the queue to be displayed in a chronological order.

According to one or more embodiments of the present disclosure, the work to be rendered comprises at least one renderable element formed by the plurality of coordinate points to be rendered; and the pattern rendering instruction further comprises a renderable element identifier; and the rendering module is configured to: group the pattern rendering instructions according to the renderable element identifiers; and for each renderable element, rank a plurality of pattern rendering instructions corresponding to the renderable element according to the time stamps to obtain a queue to be displayed corresponding to the renderable element.

According to one or more embodiments of the present disclosure, the apparatus further comprises: a detecting module, configured to detect whether the queue to be displayed comprises an unprocessed pattern rendering instruction; and a processing module, configured to if the queue to be displayed does not comprise an unprocessed pattern rendering instruction, control the external display terminal to display a predetermined work with rendering completed.

According to one or more embodiments of the present disclosure, a correspondence between the renderable element and a predetermined identifier is present; the rendering module is configured to: determine location information of the external display terminal and determining a predetermined identifier corresponding to the external display terminal according to the location information; detect whether a renderable element in the pattern rendering instruction matches the predetermined identifier corresponding to the external display terminal; if the renderable element in the pattern rendering instruction matches the predetermined identifier corresponding to the external display terminal, perform a rendering operation on respective coordinate points to be rendered in a predetermined work to be rendered according to the painting attributes corresponding to the coordinate points to be rendered in the pattern rendering instruction.

According to one or more embodiments of the present disclosure, the rendering module is further configured to: if the renderable element in the pattern rendering instruction does not match the predetermined identifier corresponding to the external display terminal, obtain a next pattern rendering instruction from the queue to be displayed in a chronological order.

According to one or more embodiments of the present disclosure, the rendering module is configured to: if the external display terminal is a predetermined target external display terminal, obtain a pattern rendering instruction corresponding to each renderable element from the queue corresponding to the renderable element in a chronological order; perform the rendering operation on all coordinate points to be rendered in the predetermined work to be rendered according to painting attributes corresponding to the coordinate points to be rendered in the pattern rendering instruction corresponding to each renderable element.

According to one or more embodiments of the present disclosure, the apparatus further comprises: the obtaining module, further configured to obtain an identification pattern associated with the predetermined identifier; and obtain a renderable element comprising the predetermined identifier; a preprocessing module, configured to enter a rendering interface.

In a fourth aspect, according to one or more embodiments of the present disclosure, an apparatus for pattern rendering is provided, the apparatus implemented at an external display terminal, and comprising:
a rendering operation obtaining module, configured to obtain a rendering operation, wherein the rendering operation is obtained by, after the server side obtains a pattern rendering instruction, rendering each coordinate point to be rendered in a predetermined work to be rendered according to painting attributes corresponding to the coordinate point to be rendered in the pattern rendering instruction; and
a display module, configured to display the rendering operation in real time.

According to one or more embodiments of the present disclosure, the work to be rendered comprises a plurality of renderable elements, and a correspondence between the renderable elements and a predetermined identifier is present; the display module is configured to: determine the predetermined identifier; and display a rendering operation of a renderable element corresponding to the predetermined identifier in real time.

According to one or more embodiments of the present disclosure, the display module is configured to: obtain an interactive predetermined identifier corresponding to an interactive rendering element capable of being displayed in association with the renderable element; detect whether a rendered pattern corresponding to the interactive predetermined identifier is obtained; if the rendered pattern corresponding to the interactive predetermined identifier is obtained, display a rendering operation of a renderable element corresponding to the predetermined identifier in real time, and displaying the rendered pattern corresponding to the interactive rendered element.

According to one or more embodiments of the present disclosure, the apparatus further comprises: an identification pattern display module, configured to display an identification pattern associated with the predetermined identifier.

According to one or more embodiments of the present disclosure, the pattern rendering instruction is comprised in at least one pattern rendering instruction, and the display module is configured to: display a rendering operation corresponding to at least one pattern rendering instruction in real time.

In a fifth aspect, according to one or more embodiments of the present disclosure, an electronic device is provided, the electronic device comprising: at least one processor and a memory;
the memory storing computer executable instructions;
the at least one processor executing the computer execution instructions stored in the memory to cause the processor to perform a method of pattern rendering according to the first aspect and all possible designs of the first aspect.

In a sixth aspect, according to one or more embodiments of the present disclosure, there is provided a computer readable storage medium storing computer executable instructions thereon that, when executed by a processor, implement a method of pattern rendering according to the first aspect and all possible designs of the first aspect.

In a seventh aspect, according to one or more embodiments of the present disclosure, there is provided a computer program product comprising a computer program which, when executed by a processor, performs a method of pattern rendering according to the first aspect and all possible designs of the first aspect.

In an eighth aspect, according to one or more embodiments of the present disclosure, there is provided a computer program which, when executed by a processor, performs a method of pattern rendering according to the first aspect and all possible designs of the first aspect.

The foregoing description is merely illustration of the preferred embodiments of the present disclosure and the technical principles used herein. Those skilled in the art should understand that the disclosure scope involved therein is not limited to the technical solutions formed from a particular combination of the above technical features, but should also cover other technical solutions formed by any combination of the above technical features or their equivalent features without departing from the above disclosure concepts, e.g., technical solutions formed by replacing the above features with technical features having similar functions disclosed (without limitation) in the present disclosure.

In addition, although various operations have been depicted in a particular order, it should not be construed as requiring that the operations be performed in the particular order shown or in sequential order of execution. Multitasking and parallel processing may be advantageous in certain environments. Likewise, although the foregoing discussion includes several specific implementation details, they should not be construed as limiting the scope of the present disclosure. Some features described in the context of separate embodiments may also be realized in combination in a single embodiment. On the contrary, various features described in the context of a single embodiment may also be realized in multiple embodiments, either individually or in any suitable sub-combinations.

While the present subject matter has been described using language specific to structural features and/or method logic actions, it should be understood that the subject matter defined in the appended claims is not necessarily limited to the particular features or actions described above. On the contrary, the particular features and actions described above are merely exemplary forms of realizing the claims. With respect to the apparatus in the above embodiment, the specific manner in which each module performs an operation has been described in detail in the embodiments relating to the method, and will not be detailed herein.

1. A method of pattern rendering, the method implemented at a server side and comprising:
obtaining a pattern rendering instruction comprising a plurality of coordinate points to be rendered and painting attributes corresponding to the coordinate points to be rendered;
performing, according to the painting attributes in the pattern rendering instruction, rendering on respective coordinate points to be rendered in a predetermined work to be rendered, the painting attributes corresponding to the coordinate points to be rendered; and
in response to that a predetermined instruction is detected, sending the rendering to an external display terminal in real time so that the received rendering in real time is displayed at the external display terminal.

2. The method according to claim 1, wherein in response to that a predetermined instruction is detected, sending the rendering to an external display terminal in real time so that the received rendering in real time is displayed at the external display terminal comprises:
in response to that a rendering completion instruction is detected, sending the rendered work to the external display terminal so that the rendered work is displayed at the external display terminal.

3. The method according to claim 1, wherein the pattern rendering instruction of at least one pattern rendering instruction comprises a time stamp; and obtaining a pattern rendering instruction sent by a terminal device comprises:
ranking respective pattern rendering instructions according to the time stamps to obtain a queue to be displayed; and
obtaining pattern rendering instructions from the queue to be displayed in a chronological order.

4. The method according to claim 3, wherein the work to be rendered comprises at least one renderable element formed by the plurality of coordinate points to be rendered; and the pattern rendering instruction further comprises a renderable element identifier; and
ranking respective pattern rendering instructions according to the time stamps to obtain a queue to be displayed comprises:
grouping the pattern rendering instructions according to the renderable element identifiers; and
for each renderable element, ranking a plurality of pattern rendering instructions corresponding to the renderable element according to the time stamps to obtain a queue to be displayed corresponding to the renderable element.

5. The method according to claim 3, wherein after obtaining pattern rendering instructions from the queue to be displayed in the chronological order, the method further comprises:
detecting whether the queue to be displayed comprises an unprocessed pattern rendering instruction; and
in response to that the queue to be displayed does not comprise an unprocessed pattern rendering instruction, controlling the external display terminal to display a predetermined work with rendering completed.

6. The method according to claim 1, wherein a correspondence between the renderable element and a predetermined identifier is present;
performing, according to the painting attributes in the pattern rendering instruction, rendering on respective coordinate points to be rendered in a predetermined work to be rendered comprises:
determining location information of the external display terminal and determining a predetermined identifier corresponding to the external display terminal according to the location information;
detecting whether a renderable element in the pattern rendering instruction matches the predetermined identifier corresponding to the external display terminal; and
in response to that the renderable element in the pattern rendering instruction matches the predetermined identifier corresponding to the external display terminal, performing, according to the painting attributes in the pattern rendering instruction, rendering on respective coordinate points to be rendered in a predetermined work to be rendered.

7. The method according to claim 6, wherein after detecting whether a renderable element in the pattern rendering instruction matches the predetermined identifier corresponding to the external display terminal, the method further comprises:
in response to that the renderable element in the pattern rendering instruction does not match the predetermined identifier corresponding to the external display terminal, obtaining a next pattern rendering instruction from the queue to be displayed in a chronological order.

8. The method according to claim 6, wherein performing, according to the painting attributes in the pattern rendering instruction, rendering on respective coordinate points to be rendered in a predetermined work to be rendered comprises:
in response to that the external display terminal is a predetermined target external display terminal, obtaining a pattern rendering instruction corresponding to each renderable element from the queue corresponding to the renderable element in a chronological order; and
performing the rendering on all coordinate points to be rendered in the predetermined work to be rendered according to painting attributes corresponding to the coordinate points to be rendered in the pattern rendering instruction corresponding to each renderable element.

9. The method according to claim 1, wherein before obtaining a pattern rendering instruction, the method further comprises:
obtaining an identification pattern associated with the predetermined identifier;
obtaining a renderable element comprising the predetermined identifier; and
entering a rendering interface.

10. A method of pattern rendering, the method implemented at an external display terminal and comprising:
obtaining rendering, wherein the rendering is obtained by, after the server side obtains a pattern rendering instruction, rendering each coordinate point to be rendered in a predetermined work to be rendered according to painting attributes corresponding to the coordinate point to be rendered in the pattern rendering instruction; and
displaying the rendering in real time.

11. The method according to claim 10, wherein the work to be rendered comprises a plurality of renderable elements, and a correspondence between the renderable elements and a predetermined identifier is present; and displaying the rendering in real time comprises:
determining the predetermined identifier; and
displaying a rendering of a renderable element corresponding to the predetermined identifier in real time.

12. The method according to claim 11, further comprising:
obtaining an interactive predetermined identifier corresponding to an interactive rendering element capable of being displayed in association with the renderable element;
detecting whether a rendered pattern corresponding to the interactive predetermined identifier is obtained; and
in response to that the rendered pattern corresponding to the interactive predetermined identifier is obtained, displaying a rendering of a renderable element corresponding to the predetermined identifier in real time, and displaying the rendered pattern corresponding to the interactive rendered element.

13. The method according to claim 11, further comprising:
displaying an identification pattern associated with the predetermined identifier.

14. The method according to claim 10, wherein the pattern rendering instruction is comprised in at least one pattern rendering instruction, and displaying the rendering in real time comprises:
displaying a rendering corresponding to the at least one pattern rendering instruction in real time.

15-20. (canceled)

21. An electronic device, comprising:
a processor and a memory;
the memory storing computer executable instructions;
the processor executing the computer execution instructions stored in the memory to cause the processor to perform a method of pattern rendering comprising:
obtaining a pattern rendering instruction comprising a plurality of coordinate points to be rendered and painting attributes corresponding to the coordinate points to be rendered,
performing, according to the painting attributes in the pattern rendering instruction, rendering on respective coordinate points to be rendered in a predetermined work to be rendered, the painting attributes corresponding to the coordinate points to be rendered, and
in response to that a predetermined instruction is detected, sending the rendering to an external display terminal in real time so that the received rendering in real time is displayed at the external display terminal.

22. The device according to claim 21, wherein in response to that a predetermined instruction is detected, sending the rendering to an external display terminal in real time so that the received rendering in real time is displayed at the external display terminal comprises:
in response to that a rendering completion instruction is detected, sending the rendered work to the external display terminal so that the rendered work is displayed at the external display terminal.

23. The device according to claim 21, wherein the pattern rendering instruction of at least one pattern rendering instruction comprises a time stamp; and obtaining a pattern rendering instruction sent by a terminal device comprises:
ranking respective pattern rendering instructions according to the time stamps to obtain a queue to be displayed; and
obtaining pattern rendering instructions from the queue to be displayed in a chronological order.

24. The device according to claim 23, wherein the work to be rendered comprises at least one renderable element formed by the plurality of coordinate points to be rendered; and the pattern rendering instruction further comprises a renderable element identifier; and
ranking respective pattern rendering instructions according to the time stamps to obtain a queue to be displayed comprises:
grouping the pattern rendering instructions according to the renderable element identifiers; and
for each renderable element, ranking a plurality of pattern rendering instructions corresponding to the renderable element according to the time stamps to obtain a queue to be displayed corresponding to the renderable element.

25. The device according to claim 23, wherein after obtaining pattern rendering instructions from the queue to be displayed in the chronological order, the method further comprises:
detecting whether the queue to be displayed comprises an unprocessed pattern rendering instruction; and
in response to that the queue to be displayed does not comprise an unprocessed pattern rendering instruction, controlling the external display terminal to display a predetermined work with rendering completed.

26. The device according to claim 1, wherein a correspondence between the renderable element and a predetermined identifier is present;
performing a rendering on respective coordinate points to be rendered in a predetermined work to be rendered according to the painting attributes corresponding to the coordinate points to be rendered in the pattern rendering instruction comprises:
determining location information of the external display terminal and determining a predetermined identifier corresponding to the external display terminal according to the location information;
detecting whether a renderable element in the pattern rendering instruction matches the predetermined identifier corresponding to the external display terminal; and
in response to that the renderable element in the pattern rendering instruction matches the predetermined identifier corresponding to the external display terminal, performing a rendering on respective coordinate points to be rendered in a predetermined work to be rendered according to the painting attributes corresponding to the coordinate points to be rendered in the pattern rendering instruction.
